(19) United States
(12) Patent Application Publication
(10) Pub. No.: US 2025/0029462 A1
(43) Pub. Date: Jan. 23, 2025

(54) BLUETOOTH EARHOOK MICROPHONE APPARATUS AND NOTIFICATION METHOD THEREOF

(71) Applicant: LUXSHARE PRECISION INDUSTRY COMPANY LIMITED, SHENZHEN (CN)

(72) Inventor: Meng-Hsin KUO, Taipei City (TW)

(73) Assignee: LUXSHARE PRECISION INDUSTRY COMPANY LIMITED, SHENZHEN (CN)

(21) Appl. No.: 18/775,802

(22) Filed: Jul. 17, 2024

(30) Foreign Application Priority Data
Jul. 18, 2023 (CN) 202310880748.4

(51) Int. Cl. G08B 6/00; G10L 15/08; H04R 1/08; H04R 25/00

(52) U.S. Cl. CPC G08B 6/00; G10L 15/08; H04R 1/08; H04R 25/405; H04R 25/554; H04R 25/607; G10L 2015/088; H04R 2420/07

(57) ABSTRACT

The present disclosure is related to a Bluetooth ear-hook microphone device, which has an earhook component and a main body, and includes a microphone module, a haptic feedback module, a Bluetooth communication module, a storage module, and a processor circuit. The processor circuit executes a notification method, which includes: obtaining at least one of the audio signals; performing offline voice processing on at least one of the audio signals; and when at least one of the audio signals includes a keyword, enabling the haptic feedback module to prompt a user of the Bluetooth earhook microphone device.

### CROSS-REFERENCES

This application claims the priority benefit of Chinese Patent Application Serial Number 2023108807484, filed on Jul. 18, 2023, the full disclosure of which is incorporated herein by reference.

### TECHNICAL FIELD

The present disclosure relates to a microphone apparatus. More specifically, the present disclosure relates to a Bluetooth earhook microphone apparatus and a notification method thereof.

### DESCRIPTION OF RELATED ART

In daily life, hearing impaired people mainly use vision to confirm changes in the surrounding environment. For example, the determination of the direction of movement is according to the changes of the traffic light signal. However, it is difficult for hearing impaired people to quickly find out the occurrence of special events (such as car horn sounds, yell from nearby pedestrians, etc.), but only rely on vision. The above situation leads hearing impaired people having safety concerns.

Therefore, it is desirous to provide a device and a method that can immediately notify hearing impaired people when a special event occurred.

### SUMMARY OF THE INVENTION

The present disclosure relates to a Bluetooth earhook microphone apparatus and a notification method thereof for processing the audio signal received and instant informing the user of the Bluetooth earhook microphone apparatus by haptic according to the textual content of the audio signal. Thus, the safety of people with hearing impaired is achieved.

To achieve at least the above objective, the present disclosure relates to a notification method based on a Bluetooth earhook microphone apparatus and comprising the steps of obtaining at least one audio signal, executing an offline voice processing to the at least one audio signal, and enabling a haptic feedback module of a Bluetooth earhook microphone apparatus to alert a user wearing the Bluetooth earhook microphone apparatus when the at least one audio signal contains a keyword.

To achieve at least the above objective, the present disclosure relates to a Bluetooth earhook microphone apparatus with an earhook component and a main body. The Bluetooth earhook microphone apparatus comprises a microphone module configured in the earhook component for generating at least one audio signal, a haptic feedback module configured in the earhook component, a Bluetooth communication module configured in the main body, a storage module configured in the main body and configured with an offline voice processing unit and a voice database storing a plurality of keywords, and a processor circuit configured in the main body and electrically connected to the microphone module, the haptic feedback module, the Bluetooth communication module and the storage module for executing a notification method that comprises the steps of obtaining the at least one audio signal, executing an offline voice processing to the at least one audio signal and enabling the haptic feedback module of the Bluetooth earhook microphone apparatus to alert a user wearing the Bluetooth earhook microphone apparatus when the at least one audio signal contains at least one keyword of the plurality of keywords.

According to the above, the Bluetooth earhook microphone apparatus and the notification method of the present disclosure can execute offline voice processing to the received audio signal in real time and use the haptic feedback module to instantly notify the user of the Bluetooth earhook microphone apparatus based on the keywords appearing in the audio signal. Therefore, through the prompts of the haptic feedback module, the user can be aware of special events that require attention in the surrounding environment. The accidents or inconveniences caused by the user's limited vision can be avoided. The effect of improving the safety of the hearing impaired people is achieved.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic of a Bluetooth earhook microphone apparatus according to an embodiment of the present disclosure;

FIG. 2 is a schematic of the Bluetooth earhook microphone apparatus according to an embodiment of the present disclosure being worn on the user's ear;

FIG. 3 is a system block schematic of the Bluetooth earhook microphone apparatus according to an embodiment of the present disclosure;

FIG. 4 is a system block schematic of the Bluetooth earhook microphone apparatus according to another embodiment of the present disclosure;

FIG. 5 is a schematic of a Bluetooth earhook microphone apparatus according to another embodiment of the present disclosure;

FIG. 6 is a flowchart of a notification method based on a Bluetooth earhook microphone apparatus according to an embodiment of the present disclosure;

FIG. 7 is a flowchart of the notification method based on a Bluetooth earhook microphone apparatus according to another embodiment of the present disclosure; and

FIG. 8 is a flowchart of the notification method based on a Bluetooth earhook microphone apparatus according to another embodiment of the present disclosure.

### DESCRIPTION OF THE INVENTION

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

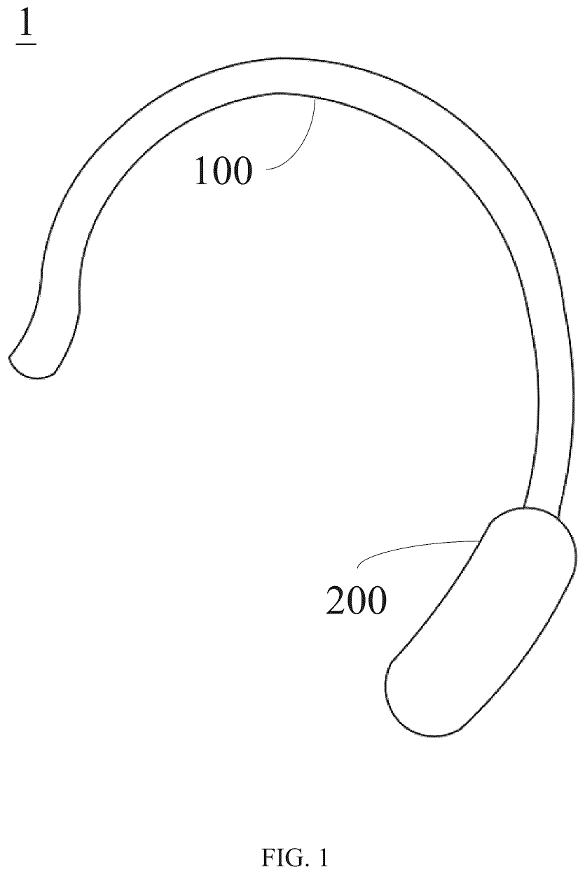

Please refer to FIG. 1. FIG. 1 is a schematic of an embodiment of a Bluetooth earhook microphone apparatus of the present disclosure. The Bluetooth earhook microphone apparatus 1 includes an earhook component 100 and a main body 200. The earhook component 100 is used for hanging on a user's ears. The main body 200 is accommodated with electronic components required for the operation of the Bluetooth earhook microphone apparatus 1.

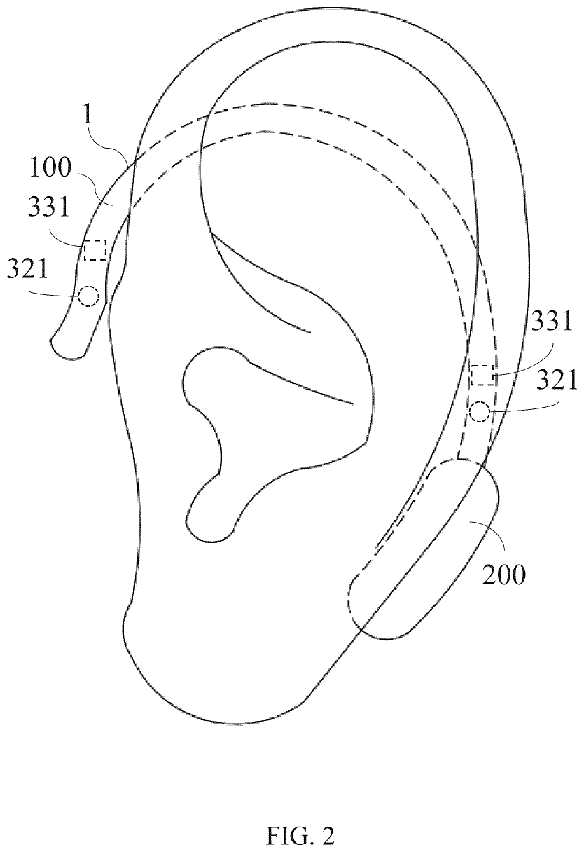

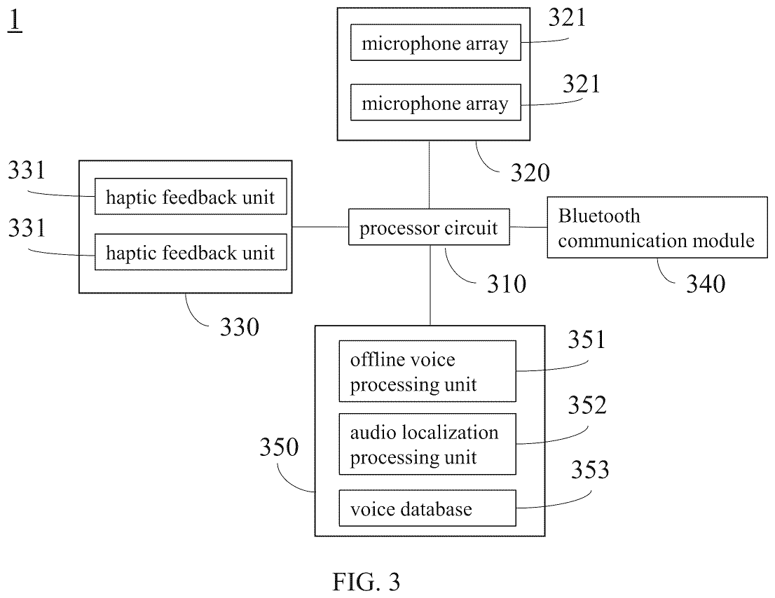

Please refer to FIGS. 2 and 3. FIG. 2 is a schematic of the Bluetooth earhook microphone apparatus being worn on the user's ear. FIG. 3 is a system architecture schematic of the Bluetooth earhook microphone apparatus 1 of the present disclosure. The Bluetooth earhook microphone apparatus 1 includes a processor circuit 310, a microphone module 320, a haptic feedback module 330, a Bluetooth communication module 340 and a storage module 350. The processor circuit 310 is electrically connected to the microphone module 320, the haptic feedback module 330, the Bluetooth communication module 340 and the storage module 350.

The microphone module 320 is configured on the earhook component 100 for generating at least one audio signal. The microphone module 320 includes a plurality of microphone arrays 321, each microphone array 321 is used to capture environmental audio and generate an audio signal. The plurality of microphone arrays 321 are disposed at different locations of the earhook component 100. For example, at least a part of the plurality of microphone arrays 321 are disposed on the earhook component 100 that close to the back of the auricle of the user's ear and/or close to the tragus of the user's ear. The present disclosure is not limited to the configuration of the examples. In a preferred embodiment, the microphone arrays 321 are at least disposed on the earhook component 100 that close to the back of the auricle of the user's ear, as shown in FIG. 2. Since there is a blind spot behind the user, it is even more necessary to capture the audio signal in the direction behind the user to knowledge the situation behind the user in real time. Thus, the accidents or inconvenience caused by the user's limited vision can be avoided and the purpose for improving the safety of the user's life is achieved.

In one embodiment, the microphone arrays 321 are, for example, linear microphone arrays, and the present disclosure is not limited thereto.

The haptic feedback module 330 is disposed on the earhook component 100. When the user wears the Bluetooth earhook microphone apparatus 1, the haptic feedback module 330 contacts the skin of the user's ear. The haptic feedback module 330 provides haptic signals to the user when the user wears the Bluetooth earhook microphone apparatus 1. The haptic feedback module 330 includes a plurality of haptic feedback unit 331, and each haptic feedback unit 331 is used to generate a haptic signal. The plurality of haptic feedback units 331 are disposed on different locations of the earhook component 100. For example, the plurality of haptic feedback units 331 are disposed on the earhook component 100 that close to the back of the auricle of the user's ear and/or close to the tragus of the user's ear (but not limited to). Therefore, since the haptic feedback module 330 is disposed on the earhook component 100, the user can be instantly prompt by the haptic signal. Accordingly, the user may pay attention to their surroundings. In addition, by individually enabling the haptic feedback units 331, the user can be reminded of the direction that needs attention. For example, the haptic feedback units 331 disposed on the earhook component 100 close to the back of the auricle of the user's ear can remind the user that a special event is happening behind him/her. Therefore, it can prevent inconveniences or accidents caused by the user delay reactions. The purpose for improving the safety of the user's life is achieved.

In one embodiment, the haptic feedback unit 331 is an electric shock element or a vibration element. Preferably, the haptic feedback unit 331 is an electrical shock element.

The Bluetooth communication module 340 is disposed in the main body 200 to communicate with an external electronic device through the Bluetooth communication protocol. In one embodiment, the Bluetooth communication module 340 communicates with the external electronic device to receive data required for the operation of the Bluetooth earhook microphone apparatus 1. In one embodiment, the Bluetooth communication module 340 communicatively connects with at least one external electronic device in a broadcast manner, and the Bluetooth communication module 340 sends a SOS message to the external electronic device.

In one embodiment, the Bluetooth communication module 340 is a Bluetooth communication chip, and the present disclosure is not limited thereto.

The storage module 350 is disposed in the main body 200. The storage module 350 includes an offline voice processing unit 351 and a voice database 353. The offline voice processing unit 351 is used to execute a voice processing on the audio signal to determine whether the audio signal includes a textual content of keywords. The voice database 353 stores with a plurality of keywords. The keywords include general keywords, emergency keywords and SOS keywords. The SOS keywords has the highest priority. The emergency keywords have higher priority than general keywords.

In one embodiment, the offline voice processing unit 351 is implemented by a trained deep neural networks (DNN), recurrent neural network (RNN) or convolutional neural network (CNN), and the present disclosure is not limited thereto. Therefore, the Bluetooth earhook microphone apparatus 1 is provided with a trained offline speech processing unit 351, which can quickly execute a voice processing at the local end (Bluetooth earhook microphone apparatus 1). The Bluetooth earhook microphone apparatus 1 does not need to wait for the external device to complete the calculation of the voice processing, thus the time required for voice processing is reduced.

In one embodiment, the SOS keywords are, for example, words such as “help me” and “save me”, and the present disclosure is not limited thereto.

In one embodiment, the emergency keywords are, for example, words such as “help”, “caution” or “stop”, and the present disclosure is not limited thereto.

In one embodiment, the general keywords are, for example, words such as “sir”, “miss”, “wait” or the name of the user, and the present disclosure is not limited thereto.

In this embodiment, the total number of words in each keyword is not greater than a word count threshold. For example, the word count threshold is 5 words. Therefore, by limiting the total number of words in a keyword, the time required to recognize the keyword can be greatly reduced. Therefore, the Bluetooth earhook microphone apparatus 1 can quickly complete the recognition of keywords to quickly prompt users based on the recognized keywords. Thereby, accidents or inconveniences caused by the user's delay reaction are avoided, and the purpose of improving the user's life safety is achieved.

In one embodiment, the storage module 350 further includes an audio localization processing unit 352. The audio localization processing unit 352 executes an audio localization processing on the audio signal to determine an audio source location of the audio signal.

In one embodiment, the offline voice processing unit 351 and the audio localization processing unit 352 are implemented by a software program, and the present disclosure is not limited thereto.

In one embodiment, the storage module 350 is a flash memory storage device, and the present disclosure is not limited thereto.

The processor circuit 310 executes a notification method of the Bluetooth ear-hook microphone device 1. The processor circuit 310 allows the microphone module 320 to continuously capture the ambient audio in real time and to generate a corresponding audio signal. The processor circuit 310 determines whether to prompt the user of the Bluetooth ear-hook microphone device 1 with the haptic signal based on the audio signal.

In this embodiment, the processor circuit 310 reads and executes the offline voice processing unit 351 of the storage module 350 to execute voice processing on the received audio signal. In one embodiment, the processor circuit 310 executes the voice processing on the received audio signal to determine whether an audio frequency information of the audio signal is greater than a preset value. When the audio frequency information of the audio signal is greater than the preset value, the audio signal is an emergency audio signal. When the audio frequency information of the audio signal is less than or equal to the preset value, the audio signal is a general audio signal. The processor circuit 310 executes a speech to text recognition on the audio signal to recognize a text information contained in the audio signal. The processor circuit 310 compares the text information with the keywords stored in the voice database 353 for determining whether the text information is one of the stored general keywords, emergency keywords or SOS keywords. When the text information of the audio signal is different from the stored keywords, it is determined that the text information of the audio signal is a non-defined keyword. When the text information of the audio signal is one of the stored keywords, it is determined whether the text information of the audio signal is a general keyword, an emergency keyword or a SOS keyword based on the audio signal is an emergency audio signal or a normal audio signal. For example, when the audio signal is determined as an emergency audio signal because of its audio frequency information, and the text information of the audio signal matches a SOS keyword, the text information of the audio signal is considered as the SOS keyword. For example, when the audio signal is determined as a general audio signal because of its audio frequency information, and the text information of the audio signal matches an general keyword, the text information of the audio signal is considered as a general keyword. By simultaneously referring to the audio frequency information and the text information to determine whether the audio signal is associated with an special event, the present disclosure can avoid misjudgment of audio signals and greatly improve the accuracy of notifications.

The processor circuit 310 reads and executes the audio localization processing unit 352 of the storage module 350 for executing an audio positioning processing on the received audio signal to determine the audio source location of the audio signal. In one embodiment, the processor circuit 310 determines a direction angle of the audio signal incident on the microphone arrays based on a beamforming algorithm (ie, to determine the audio source location of the audio signal), and the present disclosure is not limited thereto. In one embodiment, when the processor circuit 310 receives multiple audio signals at the same time, and one of the text information in the multiple audio signals matches a general keyword, and another one of text information matches an emergency keyword, the processor circuit 310 based on the priority of the text information to execute the audio positioning processing on the audio signal with higher priority. For example, when one of the text information in multiple audio signals matches a general keyword and another one of the text information matches an emergency keyword, the processor circuit 310 executes the audio positioning processing on the audio signal with the emergency keyword since the emergency keyword has a higher priority than the general keyword. Therefore, through the setting of priorities, when multiple audio signals that require attention are generated at the same time, the processor circuit 310 can prioritize the more urgent audio signals. Accidents or inconvenience caused by the user's delay reaction is prevented, and the purpose of improving the safety of the user's life is achieved.

When the text information of the audio signal is determined to be one of the keywords, the processor circuit 310 enables the haptic feedback module 330 based on the determination result of the text information, so that the haptic feedback module 330 generates a haptic signal accordingly. Therefore, the Bluetooth earhook microphone apparatus of the present disclosure can instantly prompt the user with haptic signals of the surrounding environment conditions. Thus, accidents or inconvenience caused by the user's delay reaction is avoided, and the purpose of improving the user's life safety is achieved. In one embodiment, when the text information of the audio signal is determined as one of the keywords, the processor circuit 310 enables the haptic feedback module 330 corresponding to the audio source location based on the determination result of the text information and the audio source location of the audio signal, so that the at least one haptic feedback unit 331 of the haptic feedback module 330 to generate a haptic signal accordingly. For example, when the audio source location of the audio signal is located behind the user, the processor circuit 310 enables the haptic feedback unit 331 located at the back of the ear, but not enables the haptic feedback unit 331 located at other positions. Therefore, by enabling the corresponding haptic feedback module 330, the user can be clearly notified that a special event occurs behind him or her. Accidents or inconvenience caused by the user's delay reaction is prevented, and the purpose of improving the safety of the user's life is achieved.

When the text information of the audio signal is determined as a SOS keyword, the processor circuit 310 enables the Bluetooth communication module 340 based on the determination result of the text information. The Bluetooth communication module 340 communicates with at least one external electronic device around the user in a broadcast manner and sends a SOS message to the external electronic device connected to the Bluetooth communication module 340. Therefore, by sending the SOS message through broadcasting, people around the user can quickly discover that the user needs help, and the user can receive immediate rescue, thereby improving the safety of the user's life.

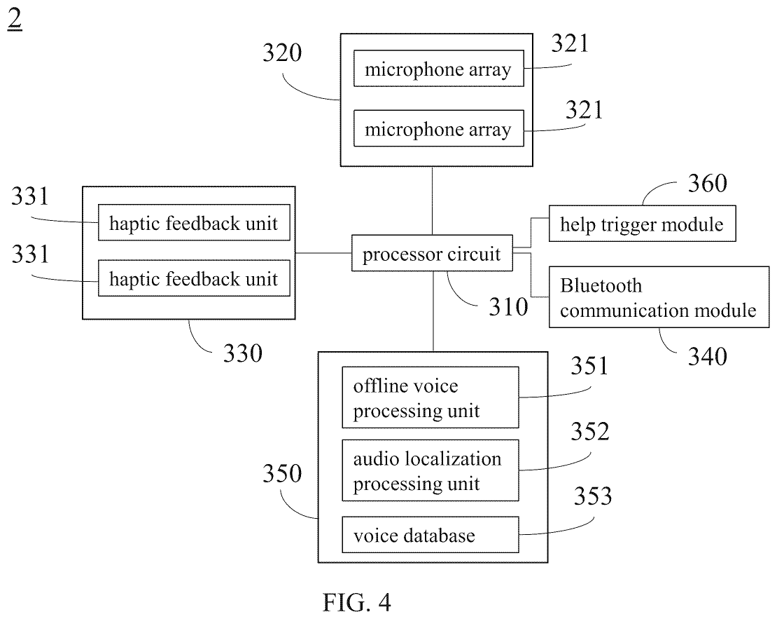

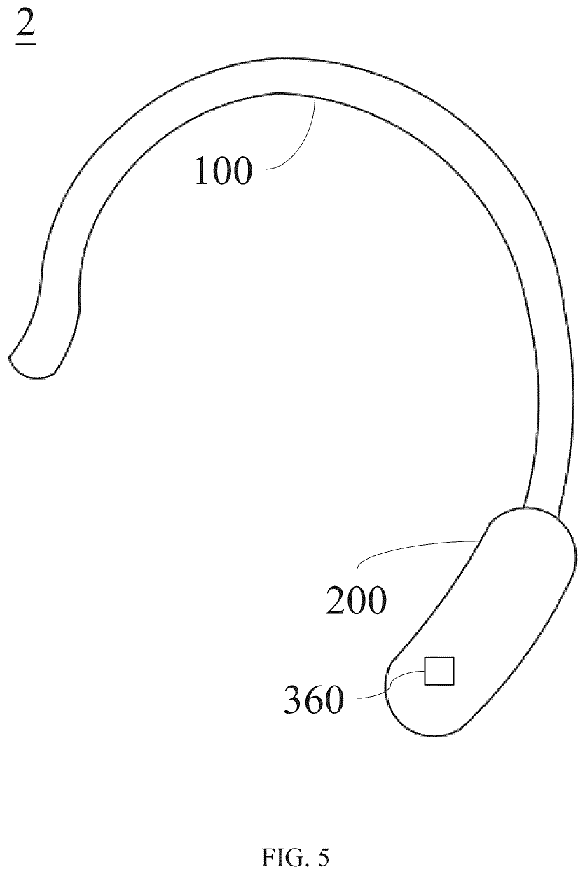

Please refer to FIG. 4. FIG. 4 is a schematic system architecture diagram of another Bluetooth earhook microphone apparatus 2 embodiment of the present disclosure. The difference between FIG. 4 and FIG. 3 is that the Bluetooth earhook microphone apparatus 2 further includes a help trigger module 360. The help trigger module 360 is electrically connected to the processor circuit 310, and the help trigger module 360 is disposed in the main body 200, as shown in FIG. 5. In one embodiment, the help trigger module 360 is a button, and the present disclosure is not limited thereto.

In this embodiment, when an emergency occurs to the user (for example, the user falls and cannot get up), the user can trigger the help trigger module to generate a SOS signal. Based on the received SOS signal, the processor circuit 310 enables the Bluetooth communication module 340 to communicate with at least one external electronic device around the user in a broadcast manner, and the Bluetooth communication module 340 sends the SOS message to the external electronic device connected to the Bluetooth communication module 340. The SOS message is, for example, a text message of “Please help me.” Therefore, by sending the SOS message through broadcasting, people around the user can quickly discover that the user needs help, and the user can receive immediate rescue, thereby the safety of the user's life is improved.

Based on the above content, a notification method based on the Bluetooth earhook microphone apparatus of the present disclosure is further summarized.

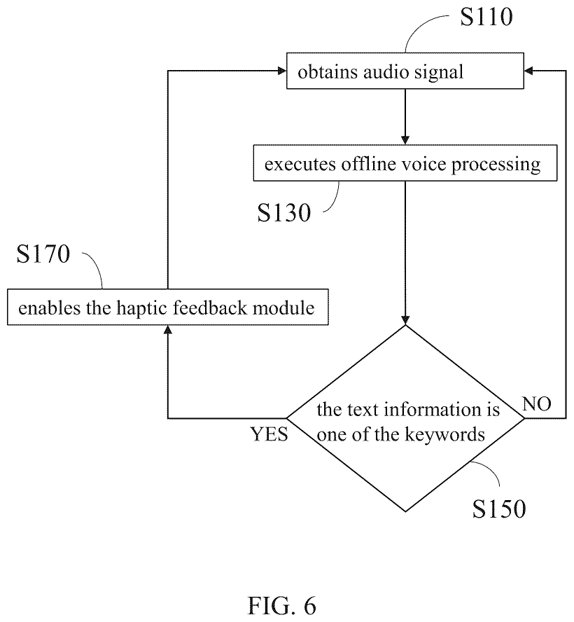

Please refer to FIG. 3 and FIG. 6. FIG. 6 is a schematic flowchart of an embodiment of a notification method based on a Bluetooth earhook microphone apparatus. The notification method including steps S110, S130, S150, and S170.

In step S110, the processor circuit 310 obtains at least one audio signal from the microphone module 320.

In step S130, the processor circuit 310 executes the offline voice processing unit 351 for determining whether the audio signal is an emergency audio signal or a general audio signal based on the audio frequency information of the audio signal and identifying the text information contained in the audio signal.

In step S150, the processor circuit 310 executes the offline voice processing unit 351 to determine whether the text information of the audio signal is a general keyword, an emergency keyword or a SOS keyword. When the text information of the audio signal is the general keyword, the emergency keyword or the SOS keyword, the step goes to step S170. Otherwise, the step goes to step S110.

In step S170, the processor circuit 310 enables the haptic feedback module 330 to generate a haptic signal to prompt the user with the haptic signal based on the determination result of step S150.

According to the above, the notification method of the present disclosure can execute offline voice processing on the received audio signal in real time, and based on the keywords appearing in the audio signal to allow the haptic feedback module to instantly notify the user of the Bluetooth earhook microphone apparatus. Therefore, the user can be aware of special events that require attention in the surrounding environment through the prompts of the haptic feedback module, thereby avoiding accidents or inconveniences caused by the user's limited vision and the purpose of improving the safety of the user's life is achieved.

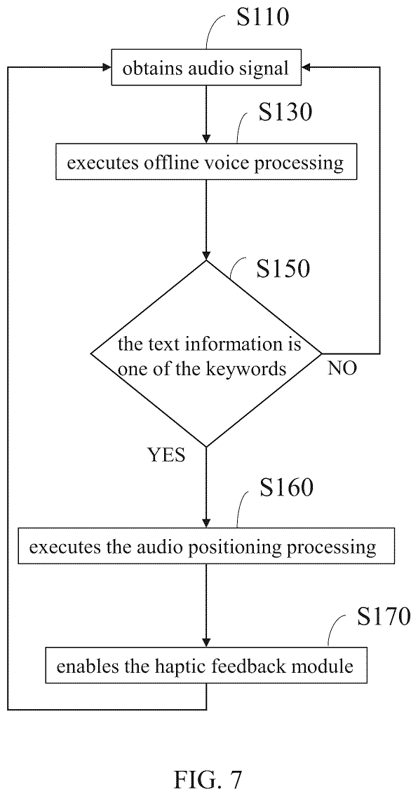

Please refer to FIG. 3 and FIG. 7. FIG. 7 is a schematic flowchart of another embodiment of a notification method based on a Bluetooth earhook microphone apparatus. The notification method including steps S110, S130, S150, S160, and S170.

The difference between the embodiments of FIG. 7 and FIG. 6 is that the notification method further includes step S160.

In step S160, based on the determination result of step S150, the processor circuit 310 executes the audio localization processing unit 352 to execute an audio positioning processing on the audio signal to determine the audio source location of the audio signal. In one embodiment, the processor circuit 310 executes the audio localization processing unit 352 based on the result of step S150 and the priority of the keyword, and the processor circuit 310 executes the audio positioning processing on the audio signal with the highest priority to determine the audio source location of the audio signal.

In step S170, based on the result of step S150 and the audio source location of the audio signal, the processor circuit 310 enables the haptic feedback module 330 corresponding to the audio source location, so that the at least one haptic feedback unit 331 of the haptic feedback module 330 generates the haptic signal accordingly. The processor circuit 310 enables the haptic feedback module 330 to generate the haptic signal to prompt the user with the haptic signal.

According to above description, the notification method of the present disclosure can execute the offline voice processing on the received audio signal in real time. The notification method of the present disclosure can instantly notify the user of the Bluetooth earhook microphone by the haptic signal that is corresponding to the audio source location of the audio signal based on the keyword from the audio signal and the audio source location of the audio signal. Therefore, through the prompts of the haptic feedback module, users can be clearly indicated the location of special events that require attention. Thus, the accidents or inconveniences caused by limited vision is avoided and the purpose of improving the safety of users' lives is achieved.

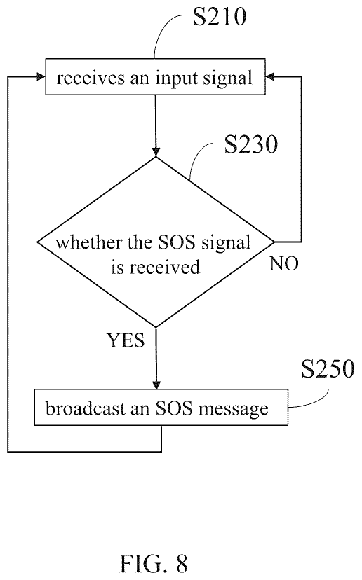

Please refer to FIG. 3 and FIG. 8. FIG. 8 is a flowchart of another embodiment of a notification method based on a Bluetooth earhook microphone apparatus. The notification method including steps S210, S230, and S250.

In step S210, in one embodiment, the processor circuit 310 receives the result of step S150 as an input signal. In another embodiment, the processor circuit 310 monitors the output signal of the help trigger module 360 in real time as the input signal.

In step S230, in one embodiment, the processor circuit 310 receives the result of step S150 and determines that the SOS signal has been received when determining that the text information of the audio signal is the SOS keyword. In one embodiment, the processor circuit 310 receives the output signal of the help trigger module 360 and determines that the SOS signal has been received when the output signal is determined as the SOS signal. When the SOS signal is received, the step goes to step S250. Otherwise, the step goes to step S210.

In step S250, the processor circuit 310 enables the Bluetooth communication module 340 to communicate with at least one external electronic device around the user in a broadcasting manner, and the Bluetooth communication module 340 sends an SOS message to the external electronic device connected to the Bluetooth communication module 340.

Through the above description, the notification method of the present disclosure, by sending an SOS message in a broadcast manner, people around the user can quickly find that the user needs help, and the user can get rescue immediately, thereby the purpose of improving the user's life safety is achieved.

In summary, the Bluetooth earhook microphone device and notification method of the present disclosure can execute the offline voice processing on the received audio signal in real time, and the user of the Bluetooth earhook microphone device can be notified in real time by the haptic signal generated by the haptic feedback module based on the keywords appearing in the audio signal. Through the prompts of the haptic feedback module, users can be aware of special events in the surrounding environment that require attention, the accidents or inconveniences caused by limited vision is avoided, and the safety of users' lives is improved. In addition, the Bluetooth earhook microphone apparatus and the notification method of the present disclosure execute the offline voice processing on the received audio signal in real time, the voice processing of the received audio signal can quickly be executed at the local end, the time required for the voice processing of the received audio signal is reduced. Moreover, the Bluetooth earhook microphone apparatus and the notification method of the present disclosure allow the haptic feedback module corresponding to the audio source location to instantly notify the user based on the keywords appearing in the audio signal and the audio source location of the audio signal. Thus, the user can be clearly indicated the location of special events that require attention. Furthermore, the Bluetooth earhook microphone apparatus and the notification method of the present disclosure, by sending the SOS message in a broadcasting manner, people around the user can quickly find that the user needs help, allowing the user to be rescued immediately.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

1. A notification method for Bluetooth earhook microphone apparatus, comprising:
obtaining at least one audio signal;
executing an offline voice processing to the at least one audio signal; and
enabling a haptic feedback module of a Bluetooth earhook microphone apparatus to alert a user wearing the Bluetooth earhook microphone apparatus when the at least one audio signal contains a keyword.

2. The notification method according to claim 1, further comprising:
executing an audio positioning processing to the at least one audio signal, and determining an audio source location of the at least one audio signal; and
enabling the haptic feedback module corresponding to the audio source location based on the at least one audio signal and the audio source location when the at least one audio signal contains the keyword.

3. The notification method according to claim 2, further comprising:
selecting one keyword from a plurality of keywords based on priorities corresponding to the plurality of keywords when the at least one audio signal contains a plurality of the keywords; and
enabling the haptic feedback module corresponding to the audio source location based on a selected keyword and the audio source location corresponding to the selected keyword.

4. The notification method according to claim 1, wherein a word count of the keyword is less than a word count threshold.

5. The notification method according to claim 1, wherein a SOS message is broadcasted through a Bluetooth communication system when the at least one audio signal contains a SOS keyword.

6. A Bluetooth earhook microphone apparatus with an earhook component and a main body, comprising:
a microphone module, configured in the earhook component for generating at least one audio signal;
a haptic feedback module, configured in the earhook component;
a Bluetooth communication module, configured in the main body;
a storage module, configured in the main body and configured with an offline voice processing unit and a voice database storing a plurality of keywords; and
a processor circuit, configured in the main body and electrically connected to the microphone module, the haptic feedback module, the Bluetooth communication module and the storage module for executing a notification method, comprising:
obtaining the at least one audio signal;
executing an offline voice processing to the at least one audio signal; and
enabling the haptic feedback module of the Bluetooth earhook microphone apparatus to alert a user wearing the Bluetooth earhook microphone apparatus when the at least one audio signal contains at least one keyword of the plurality of keywords.

7. The Bluetooth earhook microphone apparatus according to claim 6, wherein the haptic feedback module is an electrical shock element or a vibration element.

8. The Bluetooth earhook microphone apparatus according to claim 6, wherein the storage module is configured with an audio positioning processing unit configured to be executed by the processor circuit to execute an audio positioning processing to determine an audio source location of the at least one audio signal.

9. The Bluetooth earhook microphone apparatus according to claim 8, wherein the processor circuit is configured to select one keyword from a plurality of keywords contained in the least one audio signal based on priorities corresponding to the plurality of keywords contained in the least one audio signal when the at least one audio signal contains the plurality of keyword and to enable the haptic feedback module based on a selected keyword and the audio source location corresponding to the selected keyword.

10. The Bluetooth earhook microphone apparatus according to claim 6, wherein the processor circuit is configured to enable a SOS message to be broadcasted by the Bluetooth communication module when the at least one audio signal contains a SOS keyword.
